(19) United States
(12) Patent Application Publication
(10) Pub. No.: US 2014/0033849 A1
(43) Pub. Date: Feb. 6, 2014

(54) SHIFT DEVICE

(71) Applicant: KABUSHIKI KAISHA TOKAI RIKA DENKI SEISAKUSHO, Aichi (JP)

(72) Inventors: Makoto YAMAMOTO, Aichi (JP); Katsushi MIWA, Aichi (JP); Yohei NAKANO, Aichi (JP); Takehiro NIWA, Aichi (JP); Hironori WATANABE, Aichi (JP); Naomi ASAHINA, Aichi (JP)

(73) Assignee: KABUSHIKI KAISHA TOKAI RIKA DENKI SEISAKUSHO, Aichi (JP)

(21) Appl. No.: 13/952,944

(22) Filed: Jul. 29, 2013

(30) Foreign Application Priority Data
Aug. 2, 2012 (JP) 2012-172329

(51) Int. Cl. F16H 59/02

(52) U.S. Cl. CPC F16H 59/0217
USPC 74/473.12; 74/473.3

(57) ABSTRACT

A shift device provided with a shift lever that is movable from a home position to a plurality of mode selection positions including a travel mode selection position and a non-travel mode selection position. A lever holding mechanism holds the shift lever at the travel mode selection position when the shift lever is moved to the travel mode selection position and returns the shift lever from the non-travel mode selection position to the home position when the shift lever is moved to the non-travel mode selection position.

### CROSS-REFERENCE TO RELATED APPLICATIONS

This application is based upon and claims the benefit of priority from prior Japanese Patent Application No. 2012-172329, filed on Aug. 2, 2012, the entire contents of which are incorporated herein by reference.

### BACKGROUND ART

The present invention relates to a shift device used to select a transmission mode.

A shift-by-wire transmission system improves operability and allows for miniaturization of a shift device (refer to, for example, Japanese Laid-Open Patent Publication No. 2006-349016).

In a conventional shift-by-wire transmission system, when the shift lever is moved to a mode selection position, the transmission shifts transmission modes in response to an electrical signal corresponding to the mode selection position. A typical shift-by-wire transmission system often includes a momentary type shift lever. When a momentary type shift lever is released from external force that moves the shift lever to a mode selection position, the shift lever automatically returns to a home position.

A momentary shift lever is held at a home position (H) unless operated by a driver. For example, even when the present transmission mode is the drive mode (D) or the reverse mode (R), the momentary shift lever is held at the home position (H). The inventors noticed that it is difficult for the driver to intuitionally recognize the present transmission mode from the present location of the momentary shift lever.

### SUMMARY

One aspect of the present invention is a shift device provided with a shift lever that is movable from a home position to a plurality of mode selection positions including a travel mode selection position and a non-travel mode selection position. A lever holding mechanism holds the shift lever at the travel mode selection position when the shift lever is moved to the travel mode selection position and returns the shift lever from the non-travel mode selection position to the home position when the shift lever is moved to the non-travel mode selection position.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic plan view of a shift device;

FIG. 2 is a schematic perspective view of the shift device;

FIG. 3 is a schematic view of a shift lever holding mechanism;

FIG. 4 is a schematic view of a return mechanism;

FIG. 5 is a schematic view showing the return mechanism when movement of the shift lever is not restricted;

FIG. 6 is a perspective view of a movement restriction mechanism;

FIG. 7 is a cross-sectional diagram of the movement restriction mechanism when movement of the shift lever is not restricted;

FIG. 8 is a cross-sectional diagram of the movement restriction mechanism when movement of the shift lever is restricted from the H position to the D position or R position;

FIG. 9 is a cross-sectional diagram of the movement restriction mechanism when movement of the shift lever is permitted from the D position to the H position but restricted from the H position to the D position or R position;

FIG. 10 is a schematic block diagram showing the configuration of a controller for the shift device;

FIG. 11 is a flowchart showing the control performed by the controller of the shift device;

FIG. 12 is a perspective view showing a return mechanism in a further example of a shift device;

FIG. 13 is a diagram showing the shift lever released from a held state by the return mechanism of FIG. 12;

FIG. 14 is a perspective view showing a return mechanism in a further example of a shift device;

FIG. 15 is a diagram showing the shift lever released from a held state by the return mechanism of FIG. 14;

FIG. 16 is a diagram showing a movement restriction mechanism in a further example;

FIG. 17 is a diagram showing a shift pattern in a shift device of a further example;

FIG. 18 is a diagram showing a shift pattern in a shift device of a further example; and

FIG. 19 is a diagram showing a shift pattern in a shift device of a further example.

### DETAILED DESCRIPTION OF EMBODIMENTS

A shift device according to one embodiment of the present invention will now be described. In the present embodiment, the shift device is installed in an electric vehicle powered by a drive motor.

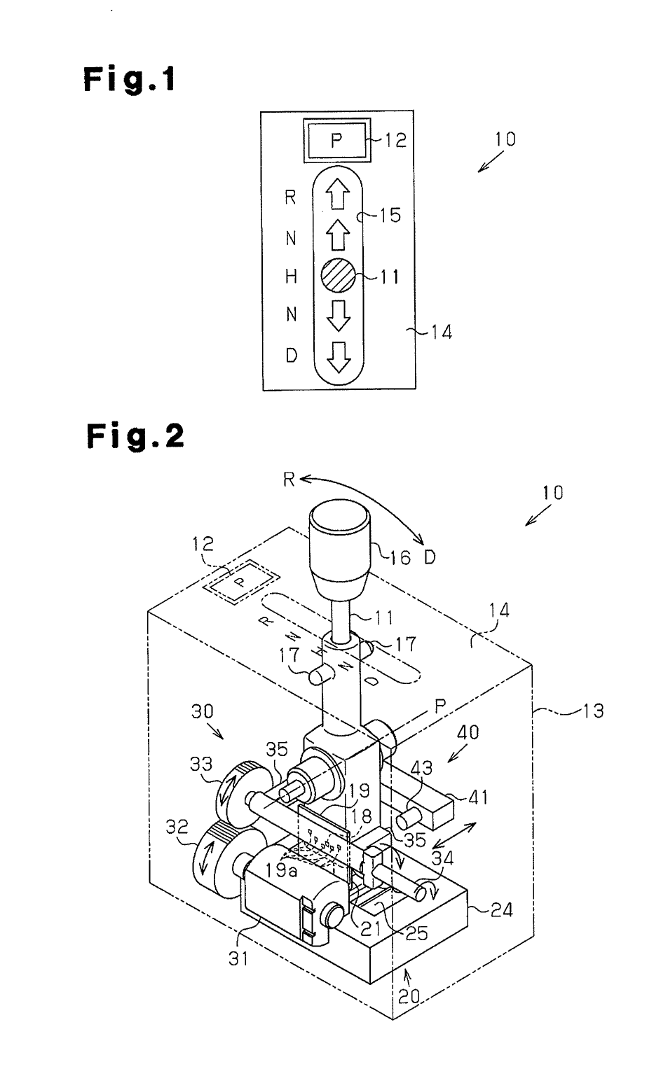

Referring to FIG. 1, the shift device 10 includes a shift lever 11 that is manually operated to select transmission modes and moved to various mode selection positions from a home position H. Further, the shift device 10 includes a parking switch 12 used to select a parking mode P. The parking switch 12 is discrete from the shift lever 11. In the illustrated example, the parking switch 12 is arranged toward the front from the movable range of the shift lever 11.

The shift device 10 is provided with a case 13 including an upper panel 14. A gate 15 is formed in the upper panel 14. The shift lever 11 is moved straight along the gate 15. A drive position D is arranged toward the rear side from the home position H, and a reverse position R is arranged toward the front side from the home position H. A neutral position (N) is arranged between the home position H and the drive position D. Another neutral position (N) is arranged between the reverse position R and the home position H. Each neutral position N corresponds to a non-travel mode in which power is not transmitted to the drive wheels.

Each neutral position N is located next to the home position H. Accordingly, the shift lever 11 is moved from the home position H to each neutral position H by one operation. At least one mode selection position (neutral position N in the illustrated example) is provided between the drive position D and the home position H. Accordingly, the shift lever 11 is moved from the home position H to the drive position D via one neutral position N by two operations. At least one mode selection position (neutral position N in the illustrated example) is included between the reverse position R and the home position H. Accordingly, the shift lever 11 is moved from the home position H to the reverse position R via one neutral position N by two operations.

The drive position D and the reverse position R may each be referred to as a travel mode selection position. Each neutral position N may be referred to as a non-travel mode selection position.

When the shift lever 11 is moved to the drive position D, the shift lever 11 is held at the drive position D. When the shift lever 11 is moved to the reverse position R, the shift lever 11 is held at the reverse position R. When the shift lever 11 is moved to the neutral position N, the shift lever 11 is returned to the home position H. Accordingly, the shift lever 11 is a hybrid of a stationary type and a momentary type.

The selection of a neutral mode will now be described.

To select the neutral mode when the shift lever 11 is held at the home position H, the driver moves the shift lever 11 from the home position H to the neutral position N. Then, the driver holds the shift lever 11 at the neutral position N for a fixed time. To select the neutral mode when the shift lever 11 is located at the drive position D or the reverse position R, the driver moves the shift lever 11 from the drive position D or the reverse position R via a neutral position N to the home position H.

Selection of a parking mode will now be described.

The driver selects the parking mode by operating the parking switch 12 when predetermined parking conditions are satisfied. Further, when the vehicle is in an active state, the driver may turn off a power switch (not shown) to select the parking mode.

Referring to FIG. 2, the shift lever 11 is pivotal about a pivot axis P. Thus, a distal end of the shift lever 11, namely, a shift knob 16, is movable toward the front side or the rear side of the vehicle. A magnet 18 is arranged on a side surface of the shift lever 11 between a basal end of the shift lever 11 and the pivot axis P. The magnet 18 opposes a substrate 19 that supports lever sensors 19a such as Hall elements. In the illustrated example, the lever sensors 19a are arranged in correspondence with the mode selection positions. A lever holding mechanism 20 is arranged on or proximal to the basal end of the shift lever 11. The lever holding mechanism 20 includes a follower pin 21 and a click unit 24, which is arranged opposing the follower pin 21 and which includes a click surface 25. The follower pin 21 and the click unit 24 cooperate to produce clicks perceived by the driver when moving the shift lever 11.

The shift device 10 includes a return mechanism 30 that is activated in response to a return request signal and configured to return the shift lever 11 from the drive position D or the reverse position R to the home position H. The return mechanism 30 includes a motor 31.

Further, the shift device 10 includes a movement restriction mechanism 40 that restricts movement of the shift lever 11 to the drive position D or the reverse position R when restriction conditions are satisfied. For example, when the vehicle is parked and the brake pedal is not depressed, the movement restriction mechanism 40 restricts movement of the shift lever 11 to the travel mode selection positions (D, R). Instead or in addition, the movement restriction mechanism 40 may restrict movement of the shift lever 11 to a travel mode selection position that drives the vehicle in a direction opposite to the present driving direction when the vehicle is travelling at a predetermined speed or greater.

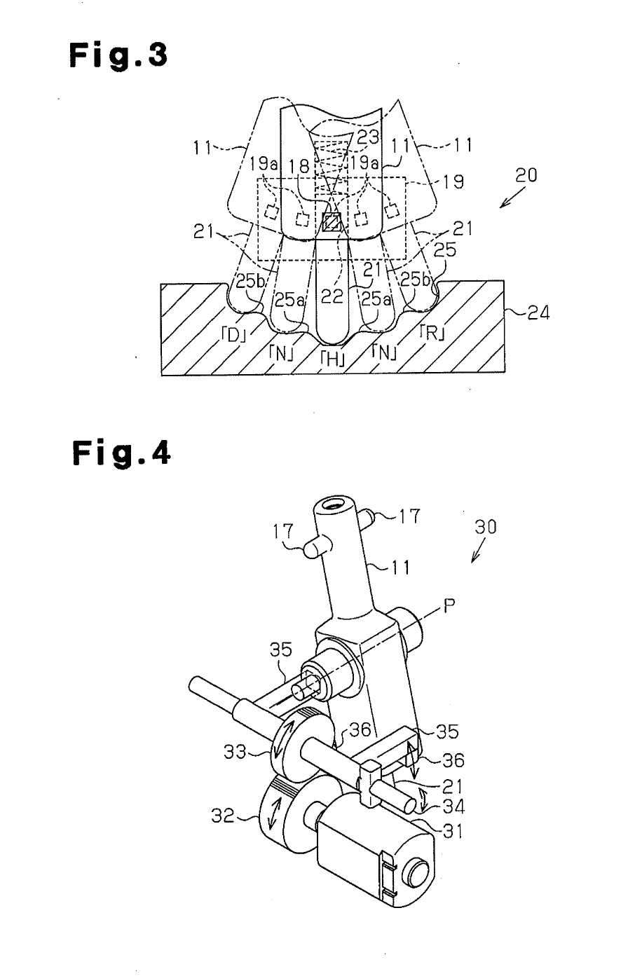

The lever holding mechanism 20 will now be described with reference to FIG. 3. A pin support 22 is arranged on the basal end of the shift lever 11 to receive a spring 23 and the follower pin 21. The spring 23 outwardly projects the follower pin 21 from the shift lever 11 and forces the follower pin 21 against the click surface 25. The click surface 25 includes two primary ridges 25a, which correspond to positions located between the home position H and each neutral position N, and two secondary ridges 25b, which correspond to a position located between the drive position D and one neutral position N and a position located between the reverse position R and the other neutral position N. Each primary ridge 25a cooperates with the spring 23 to automatically return the shift lever 11 from the corresponding neutral position N to the home position H. Each secondary ridge 25b cooperates with the spring 23 to generates a holding force that holds the shift lever 11 at the drive position D or the reverse position R. In this manner, the lever holding mechanism 20 not only automatically returns the shift lever 11 from a neutral position N to the home position H through the cooperation between a primary ridge 25a and the follower pin 21 but also holds the shift lever 11 at the drive position D or the reverse position R through the cooperation between a secondary ridge 25b and a follower pin 21. When the follower pin 21 climbs over the ridges 25a and 25b as the shift lever 11 moves from the home position H to each mode selection position, the lever holding mechanism 20 produces clicks that are perceived by the driver.

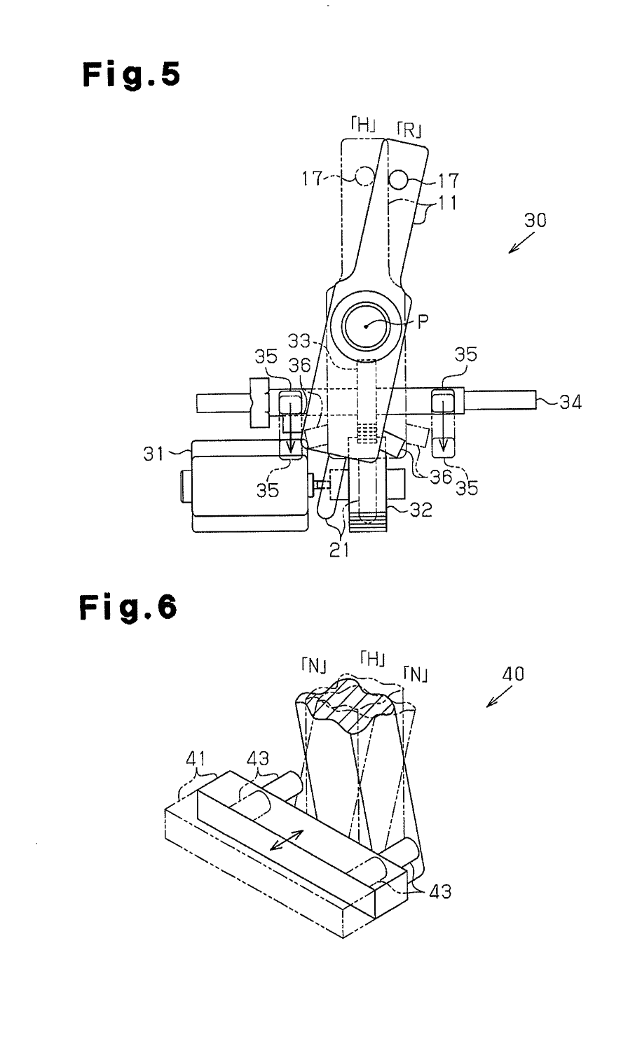

Referring to FIGS. 4 and 5, the return mechanism 30 includes the motor 31, a rotation shaft 34, which is rotated by the drive force of the motor 31, and pushing arms 35, which outwardly extend from the rotation shaft 34. In the illustrated example, the rotation shaft 34 is connected to the motor 31 by a transmission mechanism such as transmission gears 32 and 33. The rotation shaft 34 extends in the same direction as a drive shaft of the motor 31, while intersecting the pivot axis P of the shift lever 11. Projections 36 project in the movable directions of the shift lever 11 from the basal portion of the shift lever 11 proximal to the pushing arms 35. Each pushing arm 35 pushes the corresponding projection 36 to return the shift lever 11 to the home position H. In the illustrated example, the projections 36 extend diagonally in the lower direction. When the shift lever 11 is arranged at the drive position D or the reverse position R, one projection 36 may be in contact with the corresponding pushing arm 35.

With reference to FIG. 5, the returning of the shift lever 11 from the reverse position R to the home position H will now be described. First, the lever holding mechanism 20 holds the shift lever 11 at the reverse position R. Under this situation, when the motor 31 of the return mechanism 30 is driven, the transmission gears 32 and 33 rotate the rotation shaft 34. This pivots the pushing arms 35 of the rotation shaft 34, and one pushing arm 35 downwardly pushes the corresponding projection 36 to return the shift lever 11 to the home position H. Further, the follower pin 21 climbs over one of the secondary ridges 25b, and the shift lever 11 moves to the home position H. In this manner, the return mechanism 30 returns the shift lever 11 to the home position H from the drive position D or the reverse position R against the force holding the shift lever 11 generated by the lever holding mechanism 20.

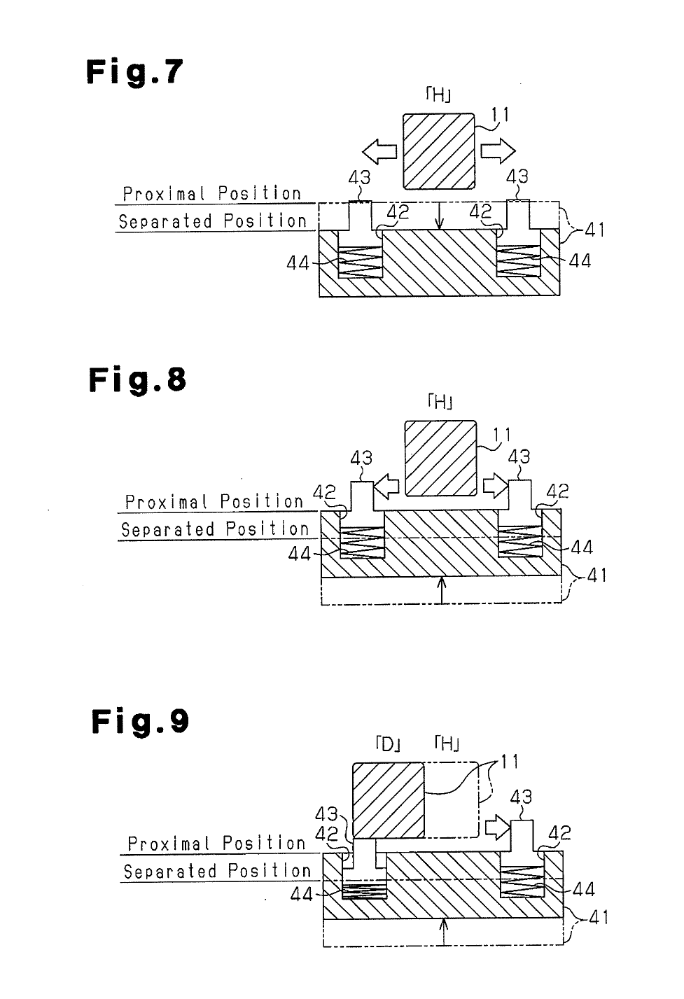

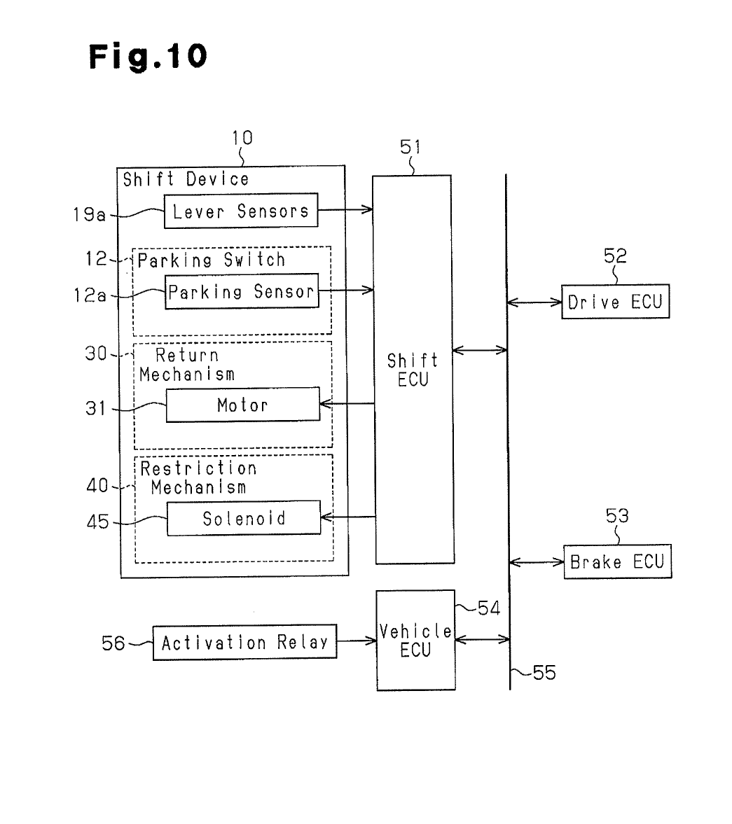

Referring to FIG. 6, the movement restriction mechanism 40 includes a lock unit 41 that is movable in a direction parallel to the pivot axis P of the shift lever 11. Referring to FIGS. 7 to 9, the lock unit 41 moves relative to a side surface of the shift lever 11 between a proximal position and a separated position. The lock unit 41 is moved by, for example, a solenoid 45 (refer to FIG. 10). The lock unit 41 includes two sockets 42 and two plungers 43 respectively projecting from the sockets 42. Each plunger 43 is elastically supported by a spring 44 in the corresponding socket 42. When the lock unit 41 is located at the proximal position relative to the shift lever 11, the shift lever 11 contacts one of the plungers 43 in accordance with the pivot direction of the shift lever 11. As a result, the movement restriction mechanism 40 restricts movement of the shift lever 11 to the drive position D and/or the reverse position R. When the lock unit 41 is located at the separated position relative to the shift lever 11, the plungers 43 do not contact the shift lever 11 regardless of the pivot direction of the shift lever 11. In this case, the movement restriction mechanism 40 does not restrict movement of the shift lever 11.

For example, in the non-restriction state shown in FIG. 7, the shift lever 11 is arranged at the home position H, and the lock unit 41 is arranged at the separated position. Under this situation, when the shift lever 11 moves, both of the plungers 43 do not contact the shift lever 11. Accordingly, movement of the shift lever 11 to each mode selection position is not restricted.

In the restriction state shown in FIG. 8, the shift lever 11 is arranged at the home position H, and the lock unit 41 is arranged at the proximal position. Under this situation, when the shift lever 11 moves, a front surface of the shift lever 11 with respect to the moving direction contacts one of the plungers 43. Thus, the shift lever 11 cannot move to the drive position D and the reverse position R.

Referring to FIG. 9, when the shift lever 11 is located at the drive position D or the reverse position R, the movement restriction mechanism 40 can move the lock unit 41 to the proximal position relative to the shift lever 11. When the lock unit 41 moves, the shift lever 11 forces one plunger 43 into the corresponding socket 42. Then, when the shift lever 11 moves from the drive position D to the neutral position N or the home position H, the resilient force of the spring 44 projects the plunger 43 that is retracted in the corresponding socket 42 out of the lock unit 41. As a result, the shift lever 11 cannot be moved from the neutral position N or the home position H to the drive position D and the reverse position R. In this manner, the movement restriction mechanism 40 restricts movement of the shift lever 11 while avoiding damages that may be caused when the shift lever 11 strikes the lock unit 41.

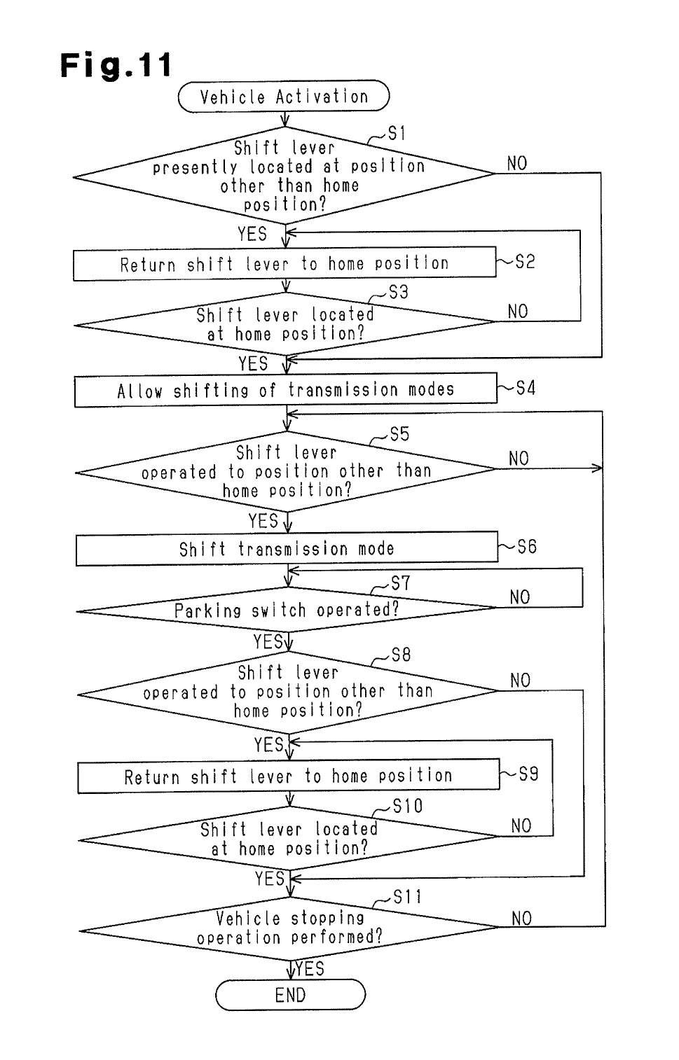

The control performed by the shift device 10 will now be described with reference to FIGS. 10 and 11.

In the example shown in FIG. 10, the shift device 10 includes the lever sensors 19a, which detect the operation of the shift lever 11, the return mechanism 30, which includes the motor 31, and the movement restriction mechanism 40, which includes the solenoid 45. The lever sensors 19a and the parking sensor 12a output detection signals (mode selection signals) in correspondence with the operation of the shift lever 11. The parking sensor 12a outputs a detection signal (parking signal) when the parking switch 12 is operated.

Based on the detection signals of the lever sensor 19a and the parking sensor 12a, a shift ECU 51 provides a control signal to various ECUs including a drive ECU 52 and a brake ECU 53. The shift ECU 51, the drive ECU 52, the brake ECU 53, and a vehicle ECU 54 are connected by a bus 55 and form an in-vehicle LAN. The drive ECU 52 controls drive devices such as the drive motor (not shown). The brake ECU 53 controls braking devices such as a parking brake. The vehicle ECU 54 acquires various types of vehicle information and sends the information to each ECU. An activation relay 56 is connected to the vehicle ECU 54.

When a start switch (not shown) is operated, the electric vehicle shifts to an activation mode. Then, when the transmission mode is shifted to the drive mode or the reverse mode and the acceleration pedal (not shown) is depressed, the drive motor is driven and the vehicle starts to travel.

The control of the shift device 10 by the shift ECU 51 will now be described with reference to FIG. 11.

As shown in FIG. 11, when the vehicle is activated, the shift ECU 51 starts controlling the shift device 10. First, to release the shift lever 11 from the restriction set by the movement restriction mechanism 40, the shift ECU 51 drives the solenoid 45 of the movement restriction mechanism 40. This moves the lock unit 41 to the separated position. Here, the shift lever 11 should be located at the home position H. However, the shift lever 11 may have been operated. Thus, the shift ECU 51 checks the present position of the shift lever 11.

In accordance with the detection signals of the lever sensors 19a, the shift ECU 51 determines whether or not the shift lever 11 is presently located at a position other than the home position (step S1). When determining that the shift lever 11 is presently located at the home position H (step S1: NO), the shift ECU 51 proceeds to step S4.

When determining that the shift lever 11 is presently located at a position other than the home position, namely, the drive position D or the reverse position R (step S1: YES), the shift ECU 51 returns the shift lever 11 to the home position (step S2). In this case, the shift ECU 51 provides the return mechanism 30 with a return request signal and drives the motor 31. As a result, one of the pushing arms 35 contacts the corresponding projection 36 of the shift lever 11 and moves the shift lever 11 to the home position H. Then, the shift ECU 51 drives the motor 31 of the return mechanism and moves the pushing arm 35 away from the projection 36.

The shift ECU 51 determines whether or not the returning operation described above has returned the shift lever 11 to the home position H based on the detection signals of the lever sensors 19a (step S3). When the shift lever 11 is located at a position other than the home position H (step S3: NO), the shift ECU 51 returns to step S2 and performs the returning operation of the shift lever 11 again.

When the shift lever 11 is returned to the home position H (step S3: YES), the shift ECU 51 allows shifting of transmission modes in correspondence with the operation of the shift lever 11 (step S4). From step S4, the driver operates the shift lever 11 to shift transmission modes.

The shift ECU 51 determines whether or not the shift lever 11 has been moved to a position other than the home position based on the detection signals of the lever sensors 19a (step S5). When the shift lever 11 is moved to a position other than the home position H (step S5: YES), the shift ECU 51 shifts the transmission mode in accordance with the operation of the shift lever 11 (step S6). For example, when the shift lever 11 is moved to the drive position D, the shift ECU 51 shifts the transmission mode to the drive mode and provides the drive ECU 52 with a forward travel control signal. When the shift lever 11 is moved to the reverse position R, the shift ECU 51 shifts the transmission mode to the reverse mode and provides the drive ECU 52 with a rearward travel control signal.

When stopping the vehicle after driving the vehicle, the driver operates the parking switch 12 and shifts the transmission mode to the parking mode. The shift ECU 51 determines whether or not the parking switch 12 has been operated (step S7). When the shift ECU 51 does not receive a detection signal from the parking sensor 12a (step S7: NO), the shift ECU 51 waits until receiving a detection signal.

When the shift ECU 51 receives a detection signal from the parking sensor 12a (step S7: YES), the shift ECU 51 shifts the transmission mode to the parking mode P. That is, regardless of the position of the shift lever 11, the shift ECU 51 shifts the transmission mode to the parking mode P. When the driver operates a parking brake switch (not shown), the shift ECU 51 provides the brake ECU 53 with a parking brake actuation signal and actuates the parking brake.

When the transmission mode is shifted to the parking mode P, the shift ECU 51 determines whether or not the shift lever 11 has returned to the home position H (step S8). When the shift lever 11 has returned to the home position H (step S8: NO), the shift ECU 51 proceeds to step S11.

When the shift lever 11 is located at a position other than the home position H, namely, the drive position D or the reverse position R (step S8: YES), the shift ECU 51 returns the shift lever 11 to the home position (step S9). The shift ECU 51 drives the motor 31 of the return mechanism 30 so that the pushing arm 35 contacts the corresponding projection 36 of the shift lever 11 and moves the shift lever 11 to the home position H. Then, the shift ECU 51 drives the motor 31 of the return mechanism 30 and moves the pushing arm 35 away from the projection 36.

The shift ECU 51 determines whether or not the returning operation described above has returned the shift lever 11 to the home position H (step S10). When the shift lever 11 is located at a position other than the home position H (step S10: NO), the shift ECU 51 performs the returning operation of the shift lever 11 again (step S9).

When the shift lever 11 is located at the home position H (step S10: YES), the shift ECU 51 determines whether or not a vehicle stopping operation has been detected (step S11). For example, a vehicle stopping operation is determined based on whether or not an ON signal of the activation relay 56 has been received from the vehicle ECU 54. When an ON signal of the activation relay 56 is received from the vehicle ECU 54, the shift ECU 51 determines that a vehicle stopping operation has not been performed (step S11: NO) and checks again whether or not the shift lever 11 has been operated (step S5).

When the ON signal of the activation relay 56 is not received, the shift ECU 51 determines that a vehicle stopping operation has been performed (step S11: YES). In this case, the driver intends to drive the vehicle and thus does not operate the shift lever 11. Accordingly, the shift ECU 51 restricts movement of the shift lever 11 with the movement restriction mechanism 40 and ends subsequent processing.

In this specification, the shift device 10 and the shift ECU 51 form a transmission mode selector.

The present embodiment has the advantages described below.

(1) When the shift lever 11 is moved to a travel mode selection position (D, R), the lever holding mechanism 20 holds the shift lever 11 at the travel mode selection position. The shift lever 11 does not return to the home position H. This allows the driver to intuitionally recognize the transmission mode. In contrast, when the shift lever 11 is moved to a non-travel mode selection position (N), the lever holding mechanism 20 returns the shift lever 11 to the home position H from the non-travel mode selection position (N). The shift lever 11 is not held at the travel mode selection position. This allows the driver to recognize that the transmission mode is not a travel mode.

(2) The travel mode selection positions are arranged so that two operations are needed to move the shift lever 11 from the home position H to a travel mode selection position (D, R). Even if the driver or a vehicle occupant unintentionally touches the shift lever 11, the shift lever 11 does not easily move to a travel mode selection position (D, R). This reduces erroneous transmission mode selection. In contrast, the shift lever 11 is moved from the home position H to a non-travel mode selection position (N) with a single operation. This allows for the driver to distinguish the operation of the shift lever 11 when shifting to a non-travel mode selection position (N) from the operation of the shift lever 11 when shifting to a travel mode selection position (D, R).

(3) The shift lever 11 is moved to a travel mode selection position (D, R) via a non-travel mode selection position (N). For example, the shift lever 11 may be unintentionally touched. In such a case, movement of the shift lever 11 to a travel mode selection position (D, R) would be incomplete. Thus, the shift lever 11 would move to a non-travel move selection position (N) and then return to the home position H. This allows for the driver to distinguish between a travel mode and a non-travel mode.

(4) When the shift lever 11 is moved to a travel mode selection position (D, R), the lever holding mechanism 20 holds the shift lever 11 at that position. However, the return mechanism 30 is activated when return conditions are satisfied to return the shift lever 11 to the home position H. Thus, when the shift lever 11 should return to the home position H such as when the vehicle is parked, the shift lever 11 automatically returns to the home position H. As a result, there is no need for the driver to return the shift lever 11 to the home position H from the travel mode selection position (D, R) when driving the vehicle the next time.

(5) When the vehicle is not in a drivable state, the movement restriction mechanism 40 restricts movement of the shift lever 11 to a travel mode selection position (D, R). This prevents the shift lever 11 from being moved or held at a travel mode selection position (D, R) when the vehicle is not in a drivable state.

It should be apparent to those skilled in the art that the present invention may be embodied in many other specific forms without departing from the spirit or scope of the invention. Particularly, it should be understood that the present invention may be embodied in the following forms.

The shift device may be installed in a vehicle other than an electric vehicle, such as an engine-driven vehicle or a hybrid electric vehicle driven by a motor and an engine.

In the return mechanism 30 of the above embodiment, the pushing arms 35 arranged on the rotation shaft 34 that is rotated in the same direction as the rotation shaft of the motor 31 contact the projections 36 of the shift lever 11. In lieu of the return mechanism 30, a return mechanism including a rotation shaft that extends in a direction differing from the rotation shaft of the motor 31 may be used.

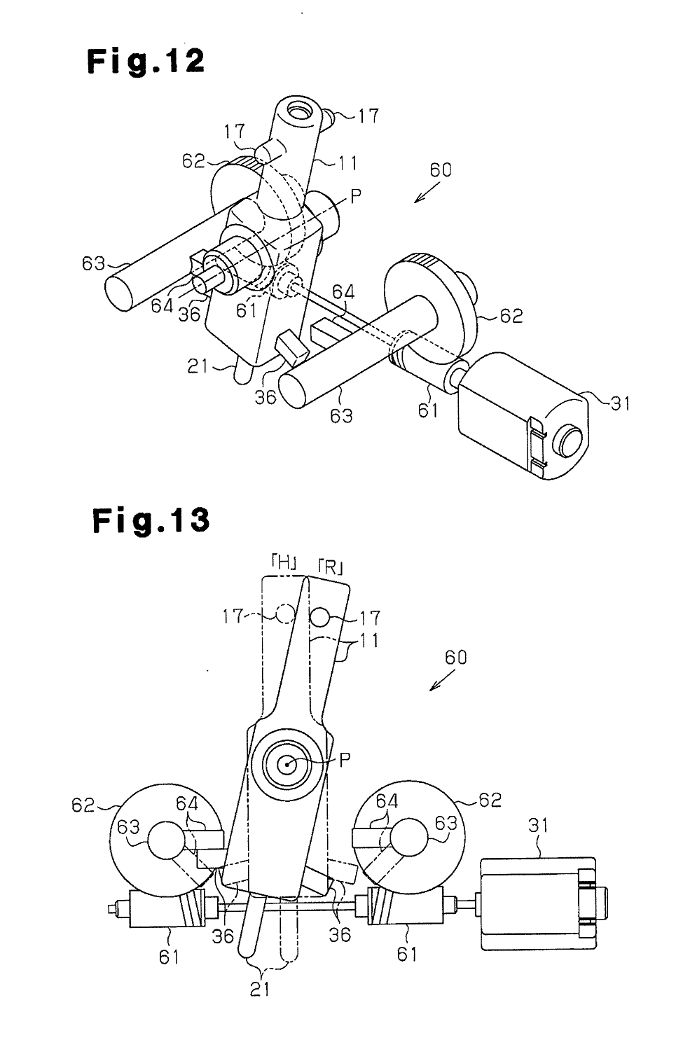

FIGS. 12 and 13 show an example in which a return mechanism 60 includes two rotation shafts 63 that rotate in a direction intersecting the rotation shaft of the motor 31. The motor has a rotation shaft including two worm gears 61. The two rotation shafts 63 are arranged on opposite sides of the shift lever 11 in the pivoting direction of the shift lever 11. The rotation shafts 63 each include a gear 62 engaged with a corresponding one of the worm gears 61. The two worm gears 61 each include a thread groove. The thread grooves of the worm gears 61 are formed to rotate the gears 62 of the two rotation shafts 63 in different rotation directions. When the motor 31 is driven, the worm gears 61 are rotated. This rotates the gears 62 together with the rotation shaft 63 thereby pivoting pushing arms 64 that contact the projections 36 of the shift lever 11. Referring to FIG. 13, when the lever holding mechanism 20 holds the shift lever 11 at the reverse position R, the motor 31 of the return mechanism 60 is driven to rotate the worm gears 61. This rotates the rotation shafts 63 and pivots the pushing arms 64 that come into contact with the projections 36 of the shift lever 11. Referring to FIG. 13, if the motor 31 of the return mechanism 60 is driven when the lever holding mechanism 20 is holding the shift lever 11 at the reverse position R, the worm gears 61 rotate and thereby rotate the rotation shafts 63 in the pivoting direction of the shift lever 11. As a result, a pushing arm 64 comes into contact with the corresponding projection 36 of the shift lever 11 and pushes the projection 36 in the downward direction. Further, the follower pin 21 climbs over a secondary ridge 25b, and the shift lever 11 pivots to the home position H.

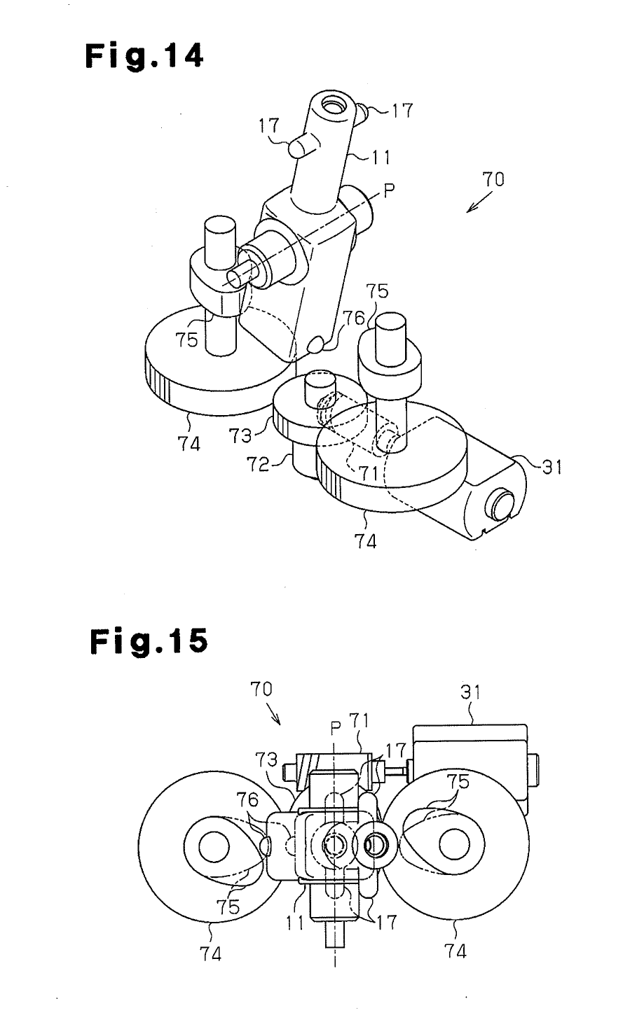

FIGS. 14 and 15 show an example in which a return mechanism 70 includes a worm gear 71 fixed to the rotation shaft of the motor 31, a rotation unit 72 intersecting and engaging the worm gear 71, a primary gear 73 rotated with the rotation unit 72, and secondary gears 74 engaged with the primary gear 73. The primary gear 73 is engaged with the two secondary gears 74, the axes of which extend in the same direction as the axis of the primary gear 73. A cam 75 is coupled to the rotation shaft of each secondary gear 74. Two semispherical projections 76 that contact the rotated cams 75 are arranged on the side surfaces of the shift lever 11 in the pivoting direction. Referring to FIG. 15, if the motor 31 of the return mechanism 70 is driven when the lever holding mechanism 20 holds the shift lever 11 at the reverse position R, the worm gear 71 is rotated. This rotates the primary gear 73 and the secondary gears 74. The rotation of the secondary gears 74 rotates the cams 75 that contact the projections 76 of the shift lever 11 and pushes the shift lever 11 toward the home position. The follower pin 21 then climbs over a secondary ridge 25b, and the shift lever 11 is further pivoted to the home position H.

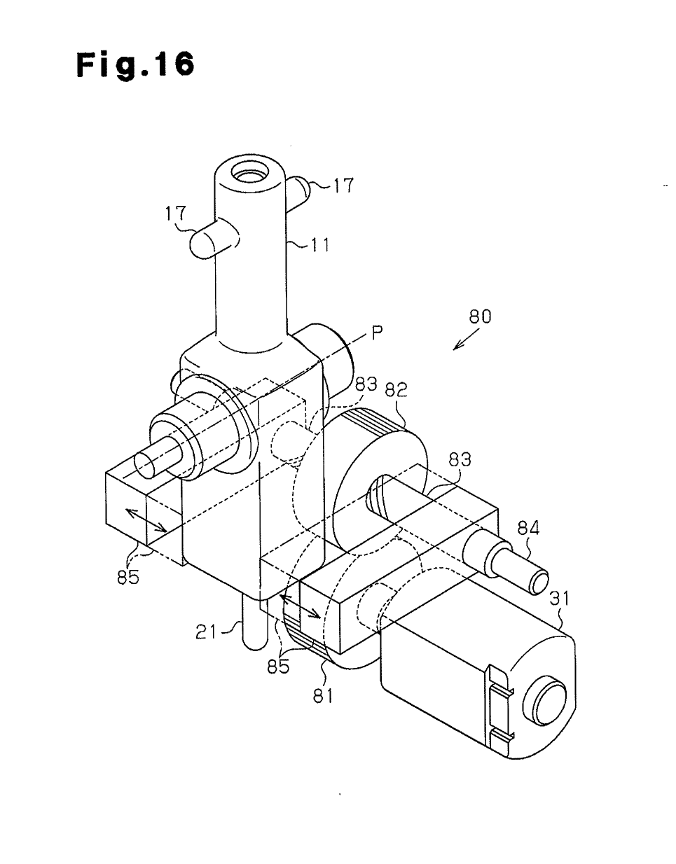

The movement restriction mechanism 40 uses a solenoid to move the lock unit 41 and set the shift lever 11 in the restriction state. However, the shift lever 11 may be set in the restriction state by a different mechanism. FIG. 16 shows an example in which a movement restriction mechanism 80 includes a primary gear 81 coupled to the rotation shaft of the motor 31, a secondary gear 82 engaged with rotated by the primary gear 81, a worm gear 83 formed on a rotation unit 84 extending in the same direction as a rotation shaft of the secondary gear 82, and lock members 85 coupled to the rotation unit 84 to restrict pivoting of the shift lever 11. The motor 31 is driven so that the lock members 85 move toward the shift lever 11 to restrict pivoting of the shift lever 11 or move away from the shift lever 11 to allow for pivoting of the shift lever 11.

The movement restriction mechanisms 40 and 80 may be omitted.

In the above embodiment, when the parking switch is operated (step S7: YES), the shift lever 11 is returned to the home position H. However, the transmission mode is set in the parking mode. Thus, the shift lever 11 does not have to return to the home position H. In this case, the shift lever 11 is returned to the home position H when the vehicle is activated.

If the shift lever 11 is not located at the home position H when the vehicle is activated, the shift device may provide a warning device such as a speaker or a display with a warning signal to generate a warning notifying the driver that the shift lever 11 is not located at the home position. This prompts the driver to move the shift lever 11 to the home position H. Activation of the vehicle may refer to when the drive motor is activated and/or when the engine is started.

The return mechanisms 30, 60, and 70 may be omitted.

The lever sensors 19a may detect the pivot angle of the pivot axis P.

In the above embodiment, the reverse position R is arranged at the front side, and the drive position D is arranged at the rear side. However, the drive position D may be arranged at the front side, and the reverse position R may be arranged at the rear side.

In the above embodiment, the shift lever 11 is moveable straight in the front-to-rear direction of the vehicle. Instead, the shift lever 11 may be movable straight in the vertical direction.

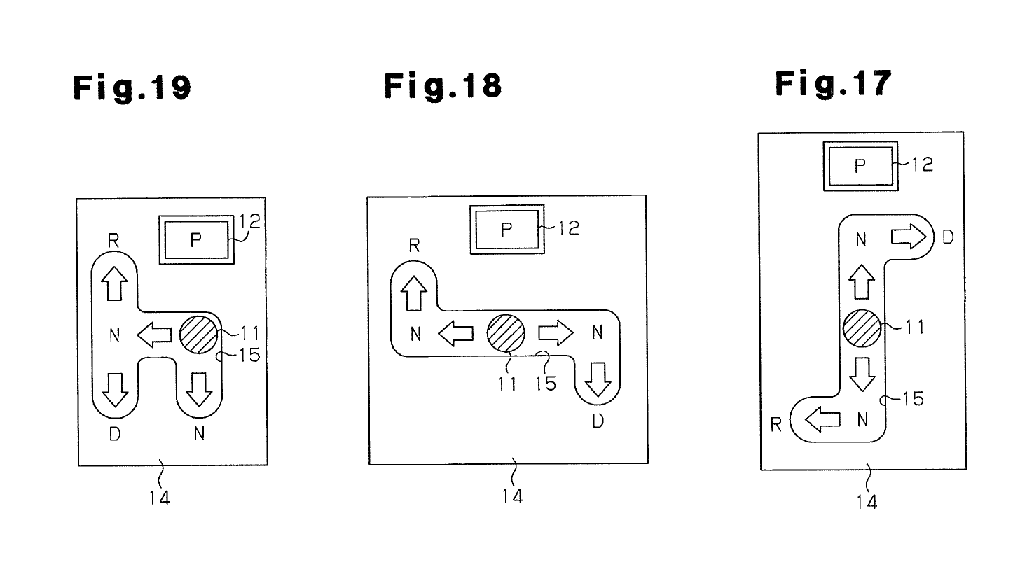

In the above embodiment, the shift lever 11 is movable straight along the gate 15. Instead, the shift lever 11 may be formed to be movable along a gate including branching points and bending points. FIGS. 17 to 19 show such examples. In these cases, the parking switch 12 is located at the upper side of the upper panel 14 as viewed in the drawings. In the example of FIG. 17, the neutral positions N are arranged at the upper and lower sides of the home position H as viewed in the drawing, the drive position D is arranged at the right side of the upper neutral position N as viewed in the drawing, and the reverse position R is arranged at the left side of the lower neutral position N as viewed in the drawing. In the example of FIG. 18, the neutral positions N are arranged at the left and right sides of the home position H as viewed in the drawing, the drive position D is arranged at the lower side of the right neutral position N as viewed in the drawing, and the reverse position R is arranged at the upper side of the left neutral position N as viewed in the drawing. Further, in the example shown in FIG. 19, the neutral position N is arranged at the left side of the home position H as viewed in the drawing, the drive position D is arranged at the lower side of the neutral position N as viewed in the drawing, and the drive position D is arranged at the lower side of the neutral position N as viewed in the drawing. This shift layout may be arranged in the front-to-rear direction of the vehicle or the vertical direction.

In the above embodiment, the parking switch 12 is arranged toward the front side of the vehicle from the movable range of the shift lever 11. Instead, the parking switch 12 may be arranged on the distal end of the shift lever 11, that is, the upper surface of the shift knob 16. This allows for the driver to select the parking mode P without releasing his or her hand from the shift lever 11.

In the above embodiment, two operations are performed to move the shift lever 11 from the home position H to the drive position D or the reverse position. Instead, one operation or three or more operations may be performed to do so.

In the shift layout of the above embodiment, the shift lever 11 moves from the home position H via the neutral position N to the drive position D or the reverse position R. Instead, a shift layout that does not go through the neutral position N may be employed.

In the above embodiment, the parking switch 12 is used to shift to the parking mode. Instead, a parking position P may be set as one selection position of the shift lever 11.

The present examples and embodiments are to be considered as illustrative and not restrictive, and the invention is not to be limited to the details given herein, but may be modified within the scope and equivalence of the appended claims.

1. A shift device comprising:
a shift lever that is movable from a home position to a plurality of mode selection positions including a travel mode selection position and a non-travel mode selection position; and
a lever holding mechanism that holds the shift lever at the travel mode selection position when the shift lever is moved to the travel mode selection position and returns the shift lever from the non-travel mode selection position to the home position when the shift lever is moved to the non-travel mode selection position.

2. The shift device according to claim 1, wherein
the non-travel mode selection position is located next to the home position, and
the travel mode selection position is separated from the home position with at least one mode selection position arranged between the travel mode selection position and the home position.

3. The shift device according to claim 1, wherein the travel mode selection position is separated from the home position with the non-travel mode selection position arranged between the travel mode selection position and the home position.

4. The shift device according to claim 1, wherein when a vehicle is activated and the shift lever is separated from the home position, the shift device issues a notification indicating that the shift lever is separated from the home position.

5. The shift device according to claim 1, further comprising a return mechanism activated in response to a return request signal to return the shift lever that is held at the travel mode selection position by the lever holding mechanism to the home position.

6. The shift device according to claim 1, further comprising a movement restriction mechanism that restricts movement of the shift lever to the travel mode selection position when a vehicle is in a non-drivable state.

7. A transmission mode selector for use with a transmission that functions in a plurality of transmission modes including a plurality of travel modes and a non-travel mode, the transmission mode selector comprising:
a selection lever movable from a home position to any of a plurality of mode selection positions, wherein the mode selection positions include a plurality of travel mode selection positions, which respectively correspond to the plurality of travel modes, and a non-travel mode selection position, which corresponds to the non-travel mode; and
a lever holding mechanism arranged on or proximal to a basal end of the selection lever, wherein when the selection lever is moved to the non-travel mode selection position the lever holding mechanism returns the selection lever from the non-travel mode selection position to the home position, and wherein when the selection lever is moved to one of the travel mode selection positions the lever holding mechanism holds the selection lever at the one of the travel mode selection positions.

8. The transmission mode selector according to claim 7, further comprising:
a lever sensor that detects operation of the selection lever and outputs a detection signal;
a return mechanism activated in response to a return request signal; and
a control circuit that provides the return mechanism with the return request signal when the detection signal is received from the lever sensor and a return condition is satisfied,
wherein the return mechanism, when activated, returns the selection lever from any of the travel mode selection positions to the home position against a holding force generated by the lever holding mechanism and applied to the selection lever.

9. A transmission mode selector comprising:
a selection lever movable from a home position to any of a forward travel mode selection position, a rearward travel mode selection position, and a neutral position;
a lever sensor that detects operation of the selection lever and outputs a detection signal;
a lever holding mechanism arranged on or proximal to a basal end of the selection lever, wherein when the selection lever is moved to one of the forward travel mode selection position and the rearward travel mode selection position, the lever holding mechanism generates a holding force to hold the selection lever at one of the forward travel mode selection position and the rearward travel mode selection position, and wherein when the selection lever is moved to the neutral position, the selection lever automatically returns from the neutral position to the home position;
a motor activated in response to a return request signal; and
a control circuit that receives the detection signal of the lever sensor, wherein when a return condition is satisfied the control circuit provides the motor with the return request signal to return the selection lever from any of the forward travel mode selection position and the rearward travel mode selection position to the home position against the holding force generated by the lever holding mechanism and applied to the selection lever.
